(19) United States
(12) Patent Application Publication
(10) Pub. No.: US 2025/0206650 A1
(43) Pub. Date: Jun. 26, 2025

(54) Sludge And Polymer Conditioning System And Method Thereof

(71) Applicant: Adalberto Mercado Alvarado, Bayamon, PR (US)

(72) Inventor: Adalberto Mercado Alvarado, Bayamon, PR (US)

(21) Appl. No.: 19/076,765

(22) Filed: Mar. 11, 2025

Related U.S. Application Data
(63) Continuation-in-part of application No. 17/889,016, filed on Aug. 16, 2022.

(51) Int. Cl. C02F 11/147; B01F 23/40; B01F 23/43; B01F 27/71; B01F 35/71; B01F 35/75; B01F 101/00

(52) U.S. Cl. CPC C02F 11/147; B01F 23/43; B01F 23/483; B01F 27/71; B01F 35/712; B01F 35/7176; B01F 35/7547; B01F 2101/305

(57) ABSTRACT

A sludge and polymer conditioning system that includes a progressive cavity pump, a mixing reactor, a drive shaft, an actuator or motor, a first reaction chamber, a reducer connector, a check valve, a spray nozzle, and a second reaction chamber.

### CROSS-REFERENCE TO RELATED APPLICATION

This application is a continuation-in-part of, and claims the benefit of priority to, U.S. patent application Ser. No. 17/889,016, entitled “Liquid Polymer Dosing and Mixing Chamber & Pump”, and filed on Aug. 16, 2022, the contents of which are hereby incorporated by reference.

### STATEMENT REGARDING FEDERALLY SPONSORED RESEARCH AND DEVELOPMENT

N/A

### BACKGROUND OF THE INVENTION

### Field of the Invention

The present invention relates to a sludge and polymer conditioning system.

### Discussion of the Background

Sludge treatment plants commonly utilize multiple filter presses or centrifuges for sludge dewatering. Additionally, these facilities employ polymer preparation systems to enhance the dewatering process. However, a significant issue arises due to imbalances in the distribution of sludge and polymer solution, leading to inefficiencies and increased operational costs. One common imbalance occurs when a facility operates two filter presses simultaneously. The sludge is pumped at a fixed rate, for example, 200 gallons per minute (GPM). However, due to hydraulic dynamics, the distribution of this flow is uneven: one filter press may receive 125 GPM while the other receives only 75 GPM. This discrepancy introduces the first variable imbalance in the system.

Each filter press requires a specific amount of polymer solution to effectively condition the sludge. Typically, a polymer preparation system supplies the polymer solution at a rate of approximately 20 GPM. This solution is distributed between the two filter presses through a piping system. However, hydraulic forces often cause an uneven distribution, with one press receiving 5 GPM and the other receiving 15 GPM, creating a second imbalance. These imbalances in sludge and polymer flow present significant challenges for plant operators. The lack of a consistent sludge-to-polymer ratio results in excessive polymer consumption, increased operational costs, and suboptimal sludge drying. Poorly conditioned sludge retains more water, increasing transportation expenses due to the additional weight of inadequately dried material. Furthermore, if an excess of polymer is supplied to the filter press receiving less sludge, the belt may become clogged, necessitating high-pressure washing. This issue not only impacts operational efficiency but also affects water quality, as the variability in sludge removal leads to inconsistent recirculation and poor sludge separation.

A sludge and polymer conditioning system is therefore needed to address these challenges. By installing the sludge and polymer conditioning system, sludge is forced into the system, where it undergoes instant polymer conditioning. The conditioned sludge is then distributed evenly to the filter presses, ensuring a consistent and balanced flow. As a result, the sludge reaching each filter press is uniform in composition and pretreated with the appropriate amount of polymer. This innovation eliminates the variabilities inherent in conventional systems, optimizing polymer use, reducing maintenance costs, and improving sludge dewatering efficiency.

The polymer-conditioned sludge is directed through the sludge and polymer conditioning system directly to belt filter presses or decanter centrifuges without requiring additional mixing machinery or polymer connections. The system ensures that the sludge feed is poly-conditioned instantaneously, maintaining a constant and balanced feed across all dewatering machines. This technology provides absolute control over polymer dosing, polymer activation, poly-sludge mixing, and poly-conditioned sludge distribution, significantly enhancing the overall efficiency and effectiveness of sludge treatment operations.

### SUMMARY OF THE INVENTION

The subject disclosure relates to a sludge and polymer conditioning system, comprising a progressive cavity pump, a mixing reactor, a drive shaft, an actuator or motor, a first reaction chamber, a reducer connector, a check valve, a spray nozzle, and a second reaction chamber; wherein the progressive cavity pump comprises: a longitudinal structure having a first end and a second end opposite each other; a rotor and a stator; wherein the rotor is configured to interact with and fit inside the stator; wherein the first end of the progressive cavity pump includes an inlet for receiving a first substance; wherein the mixing reactor comprises: a hollow tube having a top end and a bottom end opposite each other, and wherein the mixing reactor is configured to house the drive shaft; wherein the mixing reactor includes one or more inlets attached perpendicularly to the hollow tube of the mixing reactor adapted to receive at least a second substance; wherein the drive shaft comprises: a longitudinal body having a top end, a bottom end, and one or more impellers, wherein the one or more impellers are positioned between the top end and the bottom end of the drive shaft; wherein the top end of the drive shaft includes a coupling unit that is adapted to couple with the actuator, and the bottom end of the drive shaft is coupled to the top end of the rotor; wherein the first reaction chamber comprises: a hollow tube having a top end and a bottom end opposite each other, wherein the first reaction chamber is configured to house the actuator; wherein inside the hollow tube, the first reaction chamber includes a mixing cup attached to the bottom end of the first reaction chamber and an aging cup attached to the top end of the first reaction chamber; wherein the reducer connector comprises: a hollow tube having a first end and a second end opposite each other, wherein the first end of the reducer connector comprises a diameter that is larger than the diameter of the second end of the reducer connector; wherein the check valve comprises: a longitudinal body or casing having a bottom end and a top end opposite each other, wherein the bottom end of the check valve comprises an inlet and the top end of the check valve comprises an outlet; wherein the spray nozzle comprises: a longitudinal body having a first end and a second end opposite each other, wherein the longitudinal body of the spray nozzle includes one or more orifices along its longitudinal body adapted to control the flow, direction, or spray pattern of the mixed substances; wherein the second reaction chamber comprises: a hollow cylindrical body having a top end and a bottom end opposite each other, one or more sludge inlets attached to the cylindrical body of the second reaction chamber, and wherein the top end of the second reaction chamber includes a sludge outlet; wherein the top end of the progressive cavity pump is connected to the bottom end of the mixing reactor; wherein the top end of the mixing reactor is connected to the bottom end of the first reaction chamber; wherein the top end of the first reaction chamber is connected to the first end of the reducer connector; wherein the second end of the reducer connector is connected to the bottom end of the nozzle spray; and wherein the bottom end of the nozzle spray is connected to the bottom end of the second reaction chamber.

### BRIEF DESCRIPTION OF THE DRAWINGS

FIG. 1 shows an exploded view of the components of a sludge and polymer conditioning system, in accordance with the principles of the present invention.

FIG. 2 shows a side view of the internal components of the sludge and polymer conditioning system, in accordance with the principles of the present invention.

FIG. 3 shows a top view of the internal components of the sludge and polymer conditioning system, in accordance with the principles of the present invention.

FIG. 4 shows a side view of the sludge and polymer conditioning system, in accordance with the principles of the present invention.

FIG. 5 shows a side view of the sludge and polymer conditioning system, in accordance with the principles of the present invention.

FIG. 6 shows the inlets and outlets of the sludge and polymer conditioning system, in accordance with the principles of the present invention.

FIG. 7 shows a close-up view of the mixing cup component of the sludge and polymer conditioning system, in accordance with the principles of the present invention.

FIG. 8 shows a close-up view of the aging cup component of the sludge and polymer conditioning system, in accordance with the principles of the present invention.

FIG. 9 shows a close-up view of some of the internal components of the sludge and polymer conditioning system, in accordance with the principles of the present invention.

FIG. 10 shows another close-up view of some of the internal components of the sludge and polymer conditioning system, in accordance with the principles of the present invention.

FIG. 11 shows the internal components of the sludge and polymer conditioning system, in accordance with the principles of the present invention, in accordance with the principles of the present invention.

FIG. 12 shows the flow of substances along the sludge and polymer conditioning system, in accordance with the principles of the present invention.

### DETAILED DESCRIPTION OF THE INVENTION

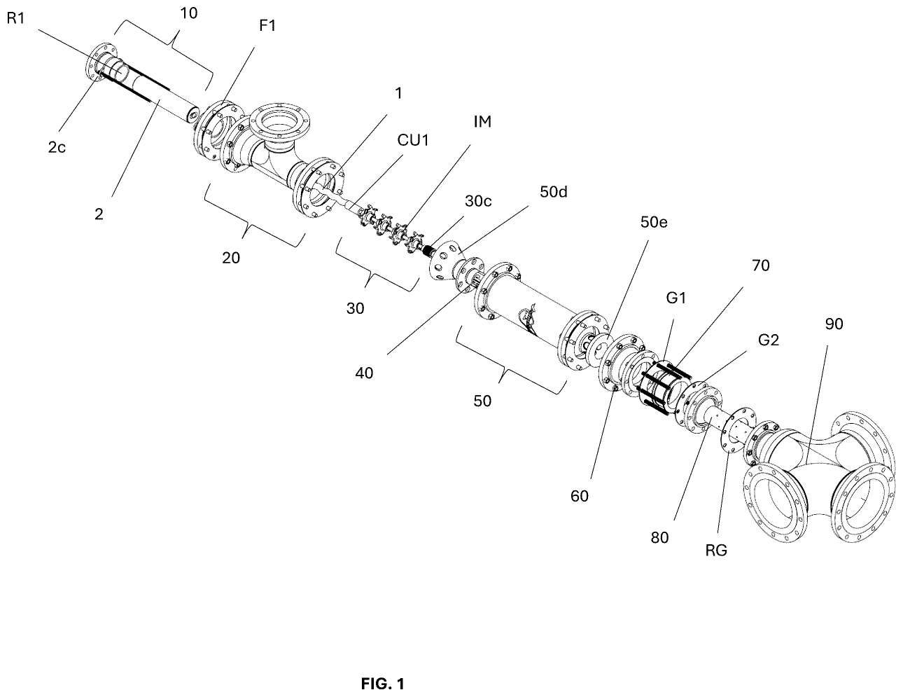

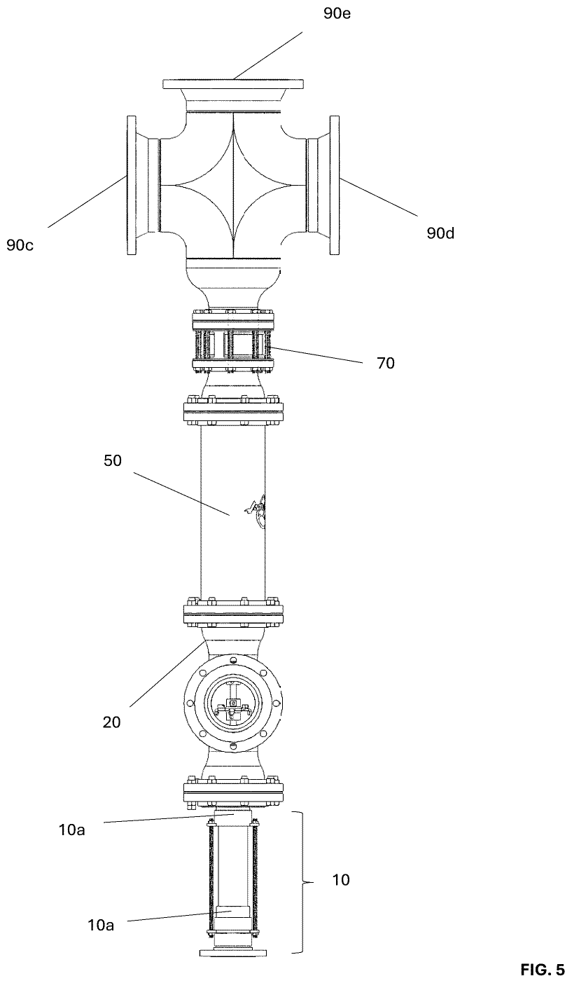

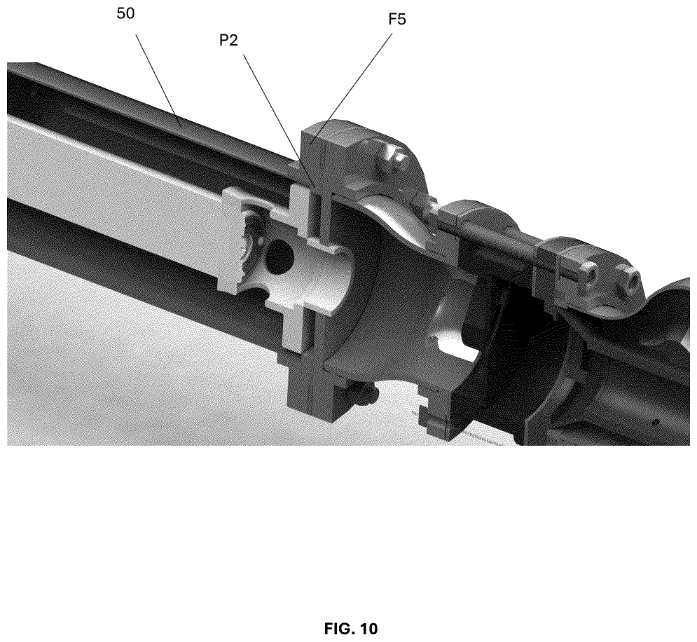

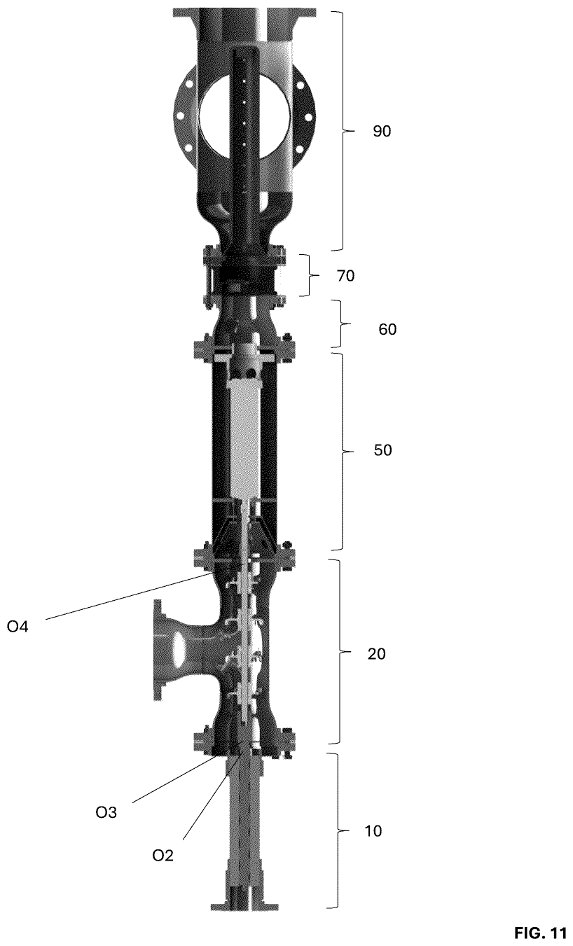

FIGS. 1-12 show a sludge and polymer conditioning system A comprising a progressive cavity pump 10, a mixing reactor 20, a drive shaft 30, an actuator or motor 40, a first reaction chamber 50, a reducer connector 60, a check valve 70, a spray nozzle 80, and a second reaction chamber 90.

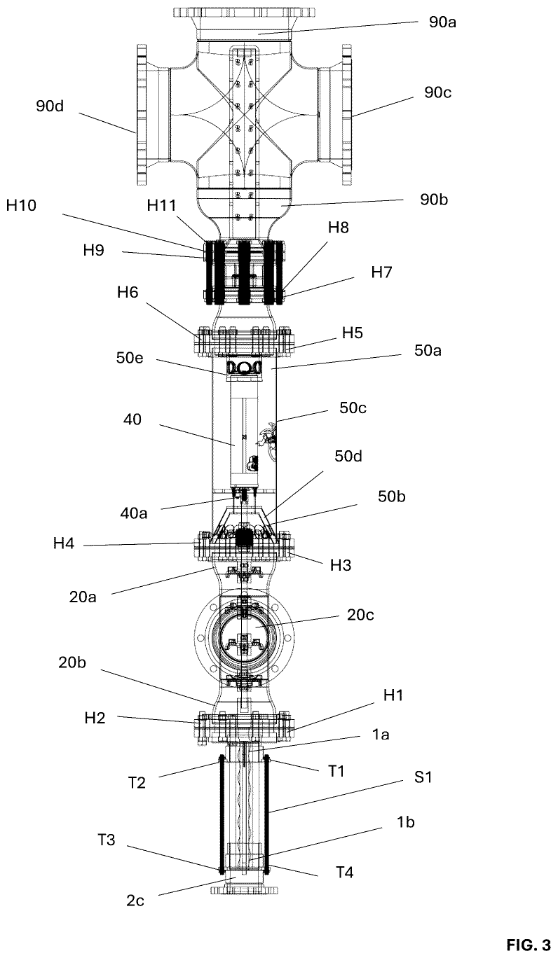

As shown in FIGS. 1-5, the progressive cavity pump 10 comprises a longitudinal structure having a first end 10a and a second end 10b opposite each other, a rotor 1, and a stator 2. It should be noted that the rotor 1 is configured to interact with and fit inside the stator 2 and that the first end 10a of the progressive cavity pump 10 includes an inlet 10c for receiving a first substance. The basic working principle of the progressive cavity pump 10 involves a rotor 1, typically made of solid metal and shaped as a single helix, rotating within the stator 2, which features a double-helix cavity. As shown in FIG. 3, the rotor 1 comprises a top end 1a and a bottom end 1b opposite each other, wherein the top end 1a of the rotor 1 includes a coupling unit CU1 configured to couple with or connect to the bottom end 30b of the drive shaft 30, thereby locking the top end 1a of the rotor 1 to the bottom end of drive shaft 30. Additionally, the stator 2, which surrounds and covers the rotor 1, also comprises a top end 2a and a bottom end 2b opposite each other.

As the rotor 1 rotates, it generates a vacuum that draws the first substance from the inlet 10c toward the mixing reactor 20. During this process, the rotor 1 divides the first substance into discrete doses as it moves through the progressive cavity pump 10. It should be noted that the rotor 1 is constructed from spiral stainless steel, but alternative materials such as high-strength plastics or other types of steel can also be used. The stator 2 typically comprises a metal pipe or tube with an internally molded cavity made from materials such as NBR, EPDM (black or white), FKM, Viton®, HNBR, PTFE, Silicone, or 3D-printed thermoplastic elastomers. Other options include branded materials such as Perbunan®, Nitrile, or Teflon®. It should also be noted that the rotor 1 is actuated or rotated by the actuator 40. Such rotation is possible because the top end 1a of the rotor 1 is coupled to the bottom end of the drive shaft 30 via the coupling unit CU1. Specifically, the coupling unit CU1 on the top end of the rotor 1 includes an opening adapted to receive the bottom end 30b of the drive shaft 30, allowing the drive shaft 30 to latch itself to the rotor 1.

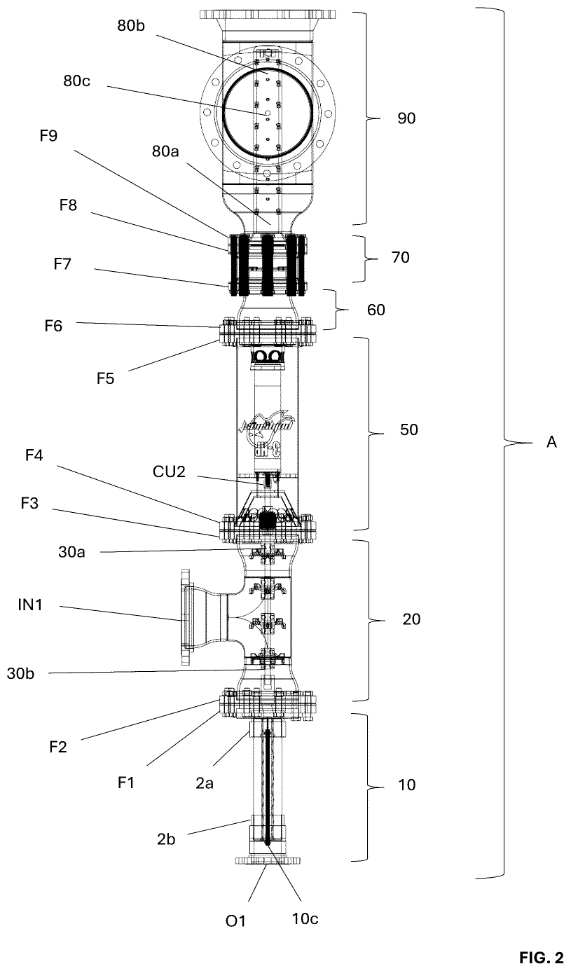

As shown in FIG. 2, the sludge and polymer conditioning system A may also include a stator base 2c adapted to hold and provide support to the stator 2. In particular, the stator base 2c comprises a hollow receptacle R1 adapted to receive and hold in place the bottom end 2b of the stator 2. The hollow receptacle R1, in turn, includes an opening O1 that corresponds with and is configured to provide access to the inlet 10c. It should be noted that the opening O1 is where the first substance or polymer reaches the inlet 10c of the progressive cavity pump 10. The first substance or polymer then passes undergoes further processing as it moves along the sludge and polymer conditioning system A. The stator base 2c may also include one or more threaded holes T1, T2 that i) correspond with the location of one or more threaded holes T3, T4 on the top end 2a of the stator 2; and ii) are adapted to receive one or more bolts or screws S1 to secure the stator base 2c to the stator 2. The top end 2a of the stator 2, on the other hand, is attached to a flange connector F1, wherein said flange connector F1 comprises a central opening O2 and one or more holes H1 along its perimeter adapted to receive one or more bolts or screws S2; and wherein the central opening O2 provides the first substance with access to the mixing reactor 20 from the progressive cavity pump 10. It should be noted that the flange connector F1 is configured to connect or interface with the bottom end 20b of the mixing reactor 20, as discussed below.

The mixing reactor 20 comprises a hollow tube 20c having a top end 20a and a bottom end 20b opposite each other, wherein the mixing reactor 20 is configured to house the drive shaft 30, as shown in FIG. 3. The bottom end 20b of the mixing reactor 20 includes an opening O3 adapted to (i) provide the first substance or polymer in the progressive cavity pump 10 with access into the interior of the mixing reactor 20; and (ii) provide the bottom end of the drive shaft 30 with access to the progressive cavity pump 10 so that it can be coupled to the rotor 1. The top end 20a of the mixing reactor 20, in turn, includes an opening O4 adapted to (i) provide the substances within the mixing reactor 20 with access to the interior of the first reaction chamber 50; and (ii) provide the top end of the drive shaft 30 with access to the first reaction chamber 50 so that it can couple with the actuator 40, as discussed below. Moreover, the hollow tube 20c of the mixing reactor 20 includes one or more inlets IN1 attached perpendicularly to the hollow tube 20c of the mixing reactor 20. The one or more inlets IN1 are adapted to receive at least a second substance (e.g., water) to be mixed in the mixing reactor 20, via the agitation of the one or more impellers IM, with the first substance drawn from the progressive cavity pump CP. Once mixing is complete, the mixed substance is led, via the opening O4 on the top end 20a of the mixing reactor 20, toward the first reaction chamber 50.

It should be noted that the top end 20a of the mixing reactor 20 includes a flange F3 configured to connect to the bottom end 50b of the first reaction chamber 50 via one or more bolts or screws S3, as shown in FIGS. 2-4. Particularly, the flange F3 on the top end 20a of the mixing reactor 20 includes one or more holes H3 that (i) align with corresponding holes H4 on the bottom end 50b of the first reaction chamber 50, and (ii) are adapted to receive the one or more bolts or screws S3 to secure the top end of the mixing reactor 20 to the bottom end 50b of the first reaction chamber 50, as further discussed below. Likewise, the bottom end 20b of the mixing reactor 20 includes a flange F2 configured to connect to the flange connector F1 via one or more bolts or screws S2. In particular, the flange F2 on the bottom end 20b of the mixing reactor 20 includes one or more holes H2 that (i) align with the one or more holes H1 on the perimeter of the flange connector F1; and (ii) are adapted to receive the one or more bolts or screws S2, thereby securing the flange connector F1 to the flange F2 on the bottom end 20b of the mixing reactor 20.

The drive shaft 30 comprises a longitudinal body having a top end 30a, a bottom end 30b, and one or more impellers IM, wherein the bottom end 30b is opposite the top end 30a and the one or more impellers IM are positioned between the top end 30a and bottom end 30b of the drive shaft 30, as further discussed below. As shown in FIGS. 2 and 3, the bottom end 30b of the drive shaft 30 is coupled to the coupling unit CU1 of the top end 1a of the rotor 1. The top end 30a of the drive shaft 30, on the other hand, includes a coupling unit CU2 that is adapted to couple with the motor shaft 40a of the actuator 40. The coupling unit CU2 on the top end 30a of the drive shaft 30 includes an opening adapted to receive the motor shaft 40a of the actuator 40, allowing the drive shaft 50 to latch itself to the actuator 40. Such connection is what drives the progressive cavity pump 10 and drive shaft 30 and allows the system to operate. The drive shaft 30 may also include a flexible joint 30c that absorbs and dissipates energy through its ability to compress, stretch, or deform elastically in response to the vibration of the drive shaft 30 during operation of the actuator 40 and impellers IM. It should be noted that the actuator 40 may be a submersible electric motor; a submersible hydraulic motor; or a pneumatic motor. The actuator 40 comprises a longitudinal body having a top end and a bottom end opposite each other, wherein the top end of the actuator 40 is adapted to fit or engage with the aging cup 50e, and wherein the bottom end of the actuator is adapted to fit or engage with the supporting base 50g of the mixing cup 50d, as discussed below. The bottom end of the actuator 40 also includes the motor shaft 40a.

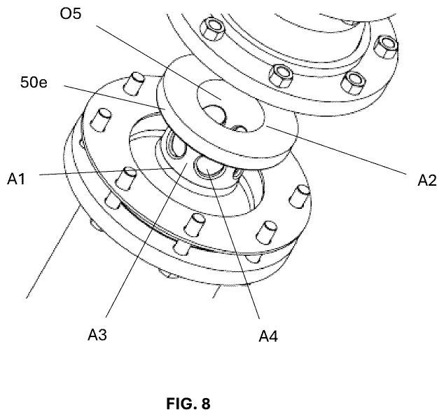

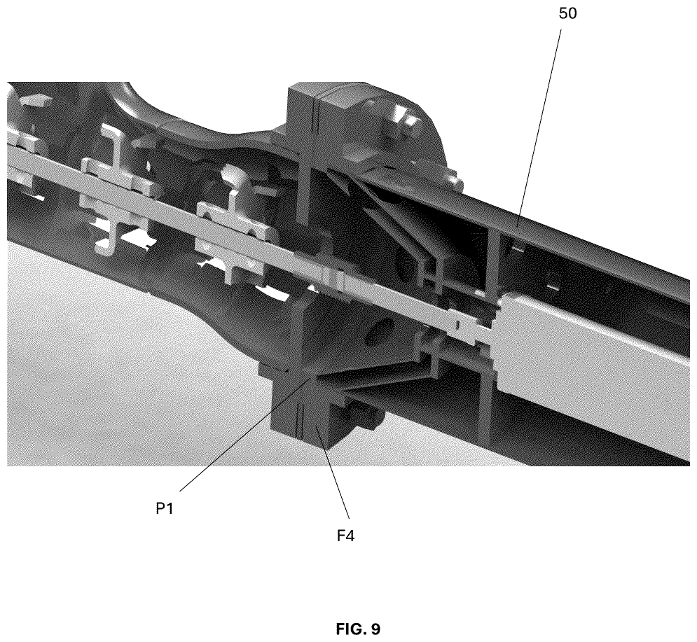

The first reaction chamber 50, in turn, comprises a hollow tube 50c having a top end 50a with a flange F5; and a bottom end 50b with a flange F4; wherein the top end 50a and the bottom end 50b are opposite each other; and wherein said first reaction chamber 50 is configured to house the actuator 40, as shown in FIGS. 2 and 3. Moreover, the interior of the first reaction chamber 50 comprises a mixing cup 50d attached to the bottom end 50b of the first reaction chamber 50; and an aging cup 50e is attached to the top end 50a of the first reaction chamber 50. Specifically, the flange F4 at the bottom end 50b of the first reaction chamber 50 includes a protruding portion P1 that prevents movement of the mixing cup 50d, as shown in FIG. 8. Similarly, the flange F5 at the top end 50a of the first reaction chamber 50 includes a protruding portion P2 that prevents movement of the aging cup 50e, as shown in FIG. 9. Once the actuator is positioned inside the first reaction chamber 50 between the mixing cup 50d and the aging cup 50e, the protruding portions P1 and P2 ensure that the mixing cup 50d, actuator 40, and aging cup 50e remain firmly secured within the first reaction chamber.

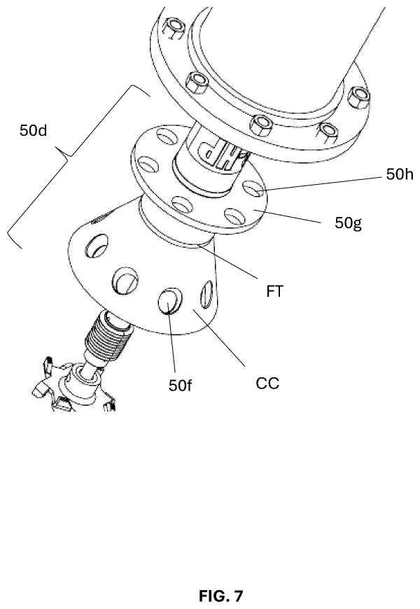

As shown in FIG. 7, the mixing cup 50d comprises a hollow conical cylinder CC having tapered walls and a truncated vertex that forms a flat top FT, wherein the tapered walls of the conical cylinder CC include one or more holes 50f that allow the mixed substances inside the mixing reactor 20 to access the reaction chamber 50. The flat top FT of the mixing cup 50d, on the other hand, includes a supporting base 50g attached thereto that is adapted to support the actuator 40. The supporting base 50g is preferably a perforated circular plate having one or more openings 50h along its perimeter which allow the mixed substances inside the mixing reactor 20 to reach the top end 50a of the reaction chamber 50. Moreover, the flat top FT of the mixing cup 50d includes a central hole adapted to provide the top end 50a of the drive shaft 30 with access to the motor shaft 40a of the actuator 40 so that the drive shaft 30 can be connected to the actuator 40. It should be noted that the actuator 40 is bolted to the supporting base 50g via one or more screws or bolts.

The aging cup 50e, in turn, comprises a hollow cylinder having longitudinal walls A3, a first end A1, and a second end A2 opposite the first end, wherein the longitudinal walls A3 are positioned between the first end A1 and the second end A2 and include one or more openings A4 that provide the mixed substances with access to the reducer connector 60, as shown in FIG. 8. The first end of the aging cup A1 is adapted to receive and hold the top end of the actuator 40 in place; whereas the second end A2 of the aging cup 50e includes a central opening O5 that leads directly into the reducer 60. As such, the mixed substances from the mixing chamber 20 pass through the tapered walls of the mixing cup 50d, then through the perforations of the supporting base 50g, and subsequently through one or more openings A4 on the longitudinal walls of the aging cup 50e. From there, the substances flow into the central opening O5 at the second end A2 of the aging cup 50e, which, as noted, leads directly into the reducer 60.

It should be noted that the flange F4 on the bottom end 50b of the first reaction chamber 50 includes one or more holes H4 that align with the one or more holes H3 on the flange F3 on the top end 20a of the mixing chamber 20; and are adapted to receive one or more the one or more bolts or screws S3 to secure the bottom end 50b of the first reaction chamber 50 to the top end 20a of the mixing chamber 20. Likewise, the top end 50a of the first reaction chamber 50 includes a flange F5 with one or more holes H5 that align with one or more holes H6 on the flange F6 of the reducer connector 60; and are adapted to receive one or more the one or more bolts or screws S4 to secure the top end 50a of the first reaction chamber 50 to the reducer connector 60. A rubber gasket may RG be placed between connecting flanges to avoid leakage of the one or more substances.

The reducer connector 60 comprises a hollow tube having a first end 60a and a second end 60b opposite each other, wherein the first end 60a comprises a diameter that is larger than the diameter of the second end 60b. This structure enables a smooth transition between varying diameters in the system, ensuring the proper flow of substances from the first reaction chamber 50 into the check valve 70. The first end 60a of the reducer 60 comprises a flange F6 that includes one or more holes H6 that align with the one or more holes H5 on the top end 50a of the first reaction chamber 50; and are adapted to receive the one or more bolts or screws S4 to secure the top end 50a of the first reactor chamber 50 to the first end 60a of the reducer connector 60. The second end 60b of the reducer connector 60, in turn, comprises a flange F7 that includes one or more holes H7 that align with the one or more holes H8 on the bottom end of the check valve 70; and are adapted to receive one or more bolts or screws S5 to secure the second end 60b of the first reducer connector 60 to the bottom end of the check valve 70. A rubber gasket may RG be placed between connecting flanges to avoid leakage of the one or more substances.

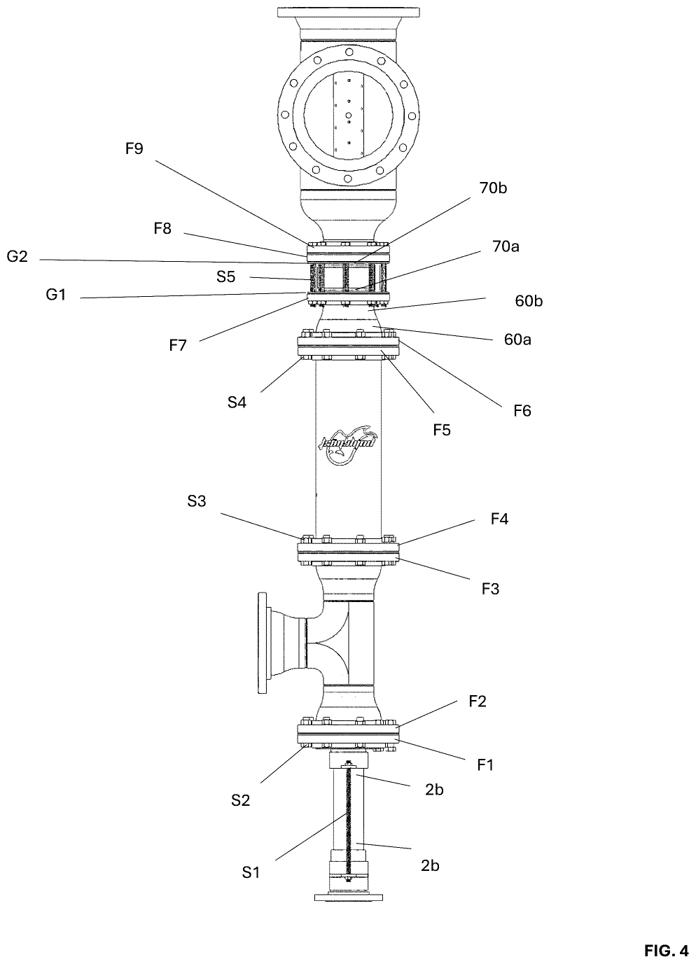

As shown in FIG. 4, the check valve 70 comprises a longitudinal body or casing having a bottom end 70a and a top end 70b opposite each other, wherein the bottom end 70a comprises an inlet and the top end 70b comprises an outlet. As known in the art, a check valve comprises a valve mechanism (not shown) within the casing that is adapted to allow or block flow such as a disc (e.g., swing check valve), a ball (e.g., ball check valve), a spring, a piston, or a diaphragm. Particularly, a swing check valve uses a hinged disc that swings open with forward flow and closes when flow stops. A ball check valve uses a ball that moves to open or block flow. A spring-loaded check valve uses a spring to push the valve shut when flow ceases. A diaphragm check valve uses a flexible diaphragm that lifts with flow and seals when pressure drops. A lift check valve uses a guided piston or disc that lifts vertically to allow flow and settles back when flow stops. As such, the check valve 70 allows fluid to flow in one direction only, preventing backflow. Particularly, the inlet at the bottom end 70a of the check valve 70 is adapted to receive the one or more mixed substances coming from the first reaction chamber 50 and to lead them toward the outlet on the top end 70b of the check valve 70 for subsequent release via the spray nozzle 80.

The bottom end 70a of the check valve 70 is attached to a gasket G1 that includes one or more holes H8 that align with the one or more holes H7 on the flange F7 at the second end 60a of the reducer connector 60; and are adapted to receive one or more bolts or screws S5 to secure the second end 60a of the reducer connector 60 to the bottom end 70a of the check valve 70. The top end 70a of the check valve 70, in turn, is attached to a gasket G2 that includes one or more holes H9 that align with the one or more holes H10 on the flange F8 of the spray nozzle 80 and with the holes H11 on the flange F9 at the bottom end 90b of the second reaction chamber 90; and are adapted to receive the one or more bolts or screws S5 to secure the top end 70b of the first check valve 70 to the flange F8 of the nozzle 80 and the flange F9 at the bottom end of the second reaction chamber 90.

The spray nozzle 80 comprises a longitudinal body having a first end 80a and a second end 80b opposite each other, wherein the longitudinal body includes one or more orifices 80c along its surface adapted to control the flow, direction, or spray pattern of the one or more mixed substances as they exit an orifice, as shown in FIG. 2. The first end 80a of the spray nozzle 80 is perpendicularly attached to a flange F8 that includes one or more holes H10 that align with (i) the one or more holes H9 on the on the gasket G2 at the top end 70a of the check valve 70 and (ii) with the holes H11 on the flange F9 at the bottom end of the second reaction chamber 90. The one or more holes H10 on the flange F8 of the spray nozzle 80 are also adapted to receive the one or more bolts or screws S5 to secure the flange F8 of the spray nozzle 80 to the top end 70a of the check valve 70 and to the flange F9 at the bottom end of the second reaction chamber 90. A rubber gasket may RG be placed between connecting flanges to avoid leakage of the one or more substances. The first end 80a of the spray nozzle 80 includes an inlet adapted to receive the one or more mixed substances coming from the check valve 70 and to lead them toward the orifices 80c along the surface of the spray nozzle 80 for release. It is worth noting that the gasket G2 at the top end 70a of the check valve 70 includes a central opening that aligns with the outlet of the check valve 70, which allows the mixed substances to gain access to the inlet of the spray nozzle 80. Additionally, the bottom end 90b of the second reaction chamber 90 includes an opening adapted to receive the spray nozzle 80, which enables the spray nozzle to access the interior of the second reaction chamber 90.

As shown in FIGS. 3, 5, and 6, the second reaction chamber 90 comprises a hollow cylindrical body having a top end 90a and a bottom end 90b opposite each other as well as one or more sludge inlets 90c, 90d perpendicularly attached to the cylindrical body, wherein the sludge inlets 90c, 90d are adapted to receive untreated sludge (i.e., sludge that has not been treated with polymer) and the top end 90a includes a sludge outlet 90e adapted to release conditioned sludge (i.e., sludge that has been treated with polymer). As noted, the bottom end 90b of the second reaction chamber 90 includes an opening adapted to receive the spray nozzle 80 so that the nozzle can gain access to the interio of the second reaction chamber 90. The bottom end 90b of the second reaction chamber 90 comprises also a flange F9 that includes one or more holes H11 that align with the one or more holes H10 on the flange F8 on the first end 80a of the spray nozzle 80 and the one or more holes H9 on the gasket G2 at the top end 70a of the check valve 70. As noted, a rubber gasket may RG be placed between connecting flanges to avoid leakage of the one or more mixed substances.

It should be noted that the second reaction chamber 90 houses the longitudinal body of the spray nozzle 80. The substances sprayed or released via the spray nozzle 80 are released within the second reaction chamber 90 to be applied evenly to sludge introduced therein. The conditioned sludge is then distributed evenly to a filter press, ensuring a consistent and balanced flow. As a result, the sludge reaching each filter press is uniform in composition and pretreated with the appropriate amount of polymer.

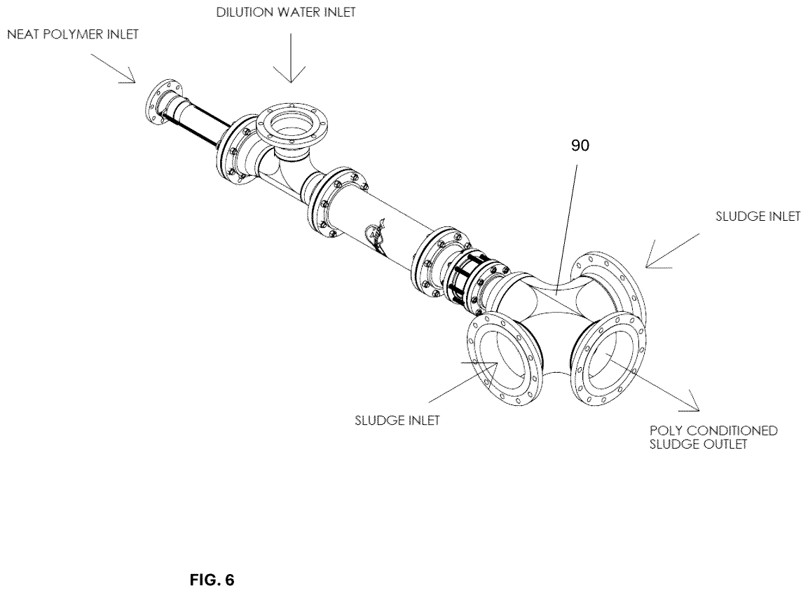

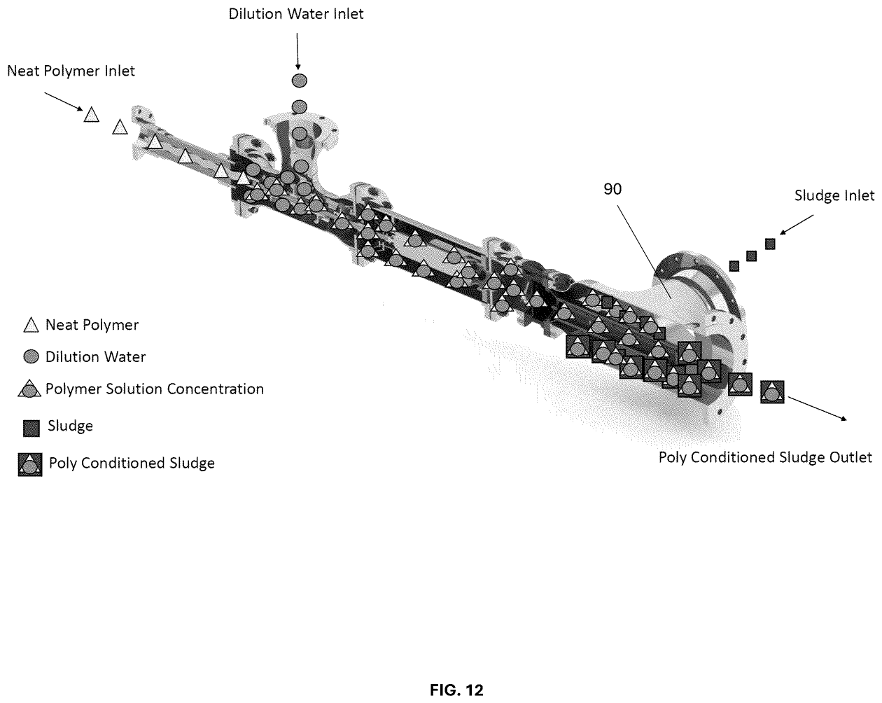

The flow of substances in the liquid polymer dosing and mixing chamber A is illustrated in FIGS. 6 and 12. The process begins with the first substance entering through the inlet 10c of the progressive cavity pump 10. After passing through the pump, the first substance is directed to the mixing reactor 20. Simultaneously, the second substance enters the mixing reactor through the one or more inlets IN1, where it combines with the first substance via the one or more impellers IM. The resulting mixture is then pushed into the first reaction chamber 50, where it undergoes further processing through the mixing cup 50d and aging cup 50e. From there, the mixture flows through the reducer connector 60 and reaches the check valve 70, which directs it to the spray nozzle 80. The spray nozzle disperses the conditioned mixture within the second reaction chamber 90 for application to the sludge. Finally, the conditioned sludge exits the system through the sludge outlet 90e.

The subject disclosure also relates to a method for conditioning sludge with a polymer solution, comprising (1) pumping a first substance into a mixing reactor via a progressive cavity pump, wherein the progressive cavity pump comprises a rotor and a stator, and the first substance is received through an inlet at a first end of the pump; (2) introducing at least a second substance into the mixing reactor via one or more inlets positioned perpendicularly to a hollow tube of the mixing reactor; (3) mixing the first and second substances using a drive shaft housed within the mixing reactor, wherein the drive shaft comprises a longitudinal body having a top end, a bottom end, and one or more impellers positioned between the top and bottom ends; (4) driving the mixing process by coupling an actuator to the top end of the drive shaft and coupling the bottom end of the drive shaft to the rotor of the progressive cavity pump; (5) directing the mixed substances from the mixing reactor into a first reaction chamber, wherein the first reaction chamber comprises a mixing cup at a bottom end and an aging cup at a top end; (6) further processing the mixed substances by passing them sequentially through the mixing cup and the aging cup within the first reaction chamber; (7) transferring the processed mixture from the first reaction chamber into a reducer connector, wherein the reducer connector comprises a hollow tube with a first end having a larger diameter than a second end; (8) controlling the flow of the processed mixture using a check valve positioned downstream of the reducer connector, wherein the check valve comprises a longitudinal body with an inlet at a bottom end and an outlet at a top end; (9) spraying the conditioned mixture through a spray nozzle having one or more orifices adapted to control the flow, direction, and spray pattern of the mixture; (10) applying the sprayed mixture within a second reaction chamber, wherein the second reaction chamber comprises a hollow cylindrical body with one or more sludge inlets and a sludge outlet at a top end; and (11) discharging the conditioned sludge from the second reaction chamber via the sludge outlet, wherein the conditioned sludge exhibits a balanced and consistent polymer-to-sludge ratio.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A sludge and polymer conditioning system, comprising:
a progressive cavity pump, a mixing reactor, a drive shaft, an actuator or motor, a first reaction chamber, a reducer connector, a check valve, a spray nozzle, and a second reaction chamber;
wherein the progressive cavity pump comprises:
a longitudinal structure having a first end and a second end opposite each other;
a rotor and a stator;
wherein the rotor is configured to interact with and fit inside the stator;
wherein the first end of the progressive cavity pump includes an inlet for receiving a first substance;
wherein the mixing reactor comprises:
a hollow tube having a top end and a bottom end opposite each other, and wherein the mixing reactor is configured to house the drive shaft;
wherein the mixing reactor includes one or more inlets attached perpendicularly to the hollow tube of the mixing reactor adapted to receive at least a second substance for mixing with the first substance;
wherein the drive shaft comprises:
a longitudinal body having a top end, a bottom end, and one or more impellers, wherein the one or more impellers are positioned between the top end and the bottom end of the drive shaft;
wherein the top end of the drive shaft includes a coupling unit that is adapted to couple with the actuator, and the bottom end of the drive shaft is coupled to the top end of the rotor;
wherein the first reaction chamber comprises:
a hollow tube having a top end and a bottom end opposite each other, wherein the first reaction chamber is configured to house the actuator;
wherein inside the hollow tube, the first reaction chamber includes a mixing cup attached to the bottom end of the first reaction chamber and an aging cup attached to the top end of the first reaction chamber;
wherein the reducer connector comprises:
a hollow tube having a first end and a second end opposite each other, wherein the first end of the reducer connector comprises a diameter that is larger than the diameter of the second end of the reducer connector;
wherein the check valve comprises:
a longitudinal body or casing having a bottom end and a top end opposite each other, wherein the bottom end of the check valve comprises an inlet and the top end of the check valve comprises an outlet;
wherein the spray nozzle comprises:
a longitudinal body having a first end and a second end opposite each other, wherein the longitudinal body of the spray nozzle includes one or more orifices along its longitudinal body adapted to control flow, direction, or spray pattern of the mixed substances;
wherein the second reaction chamber comprises:
a hollow cylindrical body having a top end and a bottom end opposite each other, one or more sludge inlets attached to the cylindrical body of the second reaction chamber, and wherein the top end of the second reaction chamber includes an outlet for releasing conditioned sludge;
wherein the top end of the progressive cavity pump is connected to the bottom end of the mixing reactor;
wherein the top end of the mixing reactor is connected to the bottom end of the first reaction chamber;
wherein the top end of the first reaction chamber is connected to the first end of the reducer connector;
wherein the second end of the reducer connector is connected to the bottom end of the nozzle spray; and
wherein the bottom end of the nozzle spray is connected to the bottom end of the second reaction chamber.

2. The sludge and polymer conditioning system of claim 1, wherein the mixing cup comprises a hollow conical cylinder having tapered walls and a truncated vertex that forms a flat top, and wherein the tapered walls of the conical cylinder include one or more holes that allow the substances in the mixing reactor to access the reaction chamber.

3. The sludge and polymer conditioning system of claim 2, wherein the flat top of the mixing cup includes a supporting base attached thereto that is adapted to support the actuator.

4. The sludge and polymer conditioning system of claim 1, wherein the aging cup comprises a hollow cylinder having longitudinal walls, a first end, and a second end opposite the first end, and wherein the longitudinal walls of the aging cup are positioned between the first end and the second end of the aging cup.

5. The sludge and polymer conditioning system of claim 4, wherein the first end of the aging cup is adapted to receive and hold a top end of the actuator in place, and the second end of the aging cup includes a central opening that leads directly into the reducer connector.

6. The sludge and polymer conditioning system of claim 1, wherein the actuator is positioned between the mixing cup and the ageing cup.

7. The sludge and polymer conditioning system of claim 1, wherein bottom end of the mixing reactor includes an opening adapted to provide the first substance in the progressive cavity pump with access into the interior of the mixing reactor, and to provide the bottom end of the drive shaft with access to the progressive cavity pump.

8. The sludge and polymer conditioning system of claim 1, wherein top end of the mixing reactor includes an opening adapted to provide the substances within the mixing reactor with access to the interior of the first reaction chamber, and to provide the top end of the drive shaft with access to the first reaction chamber for coupling with the actuator.

9. The sludge and polymer conditioning system of claim 1, wherein the actuator comprises a longitudinal body having a top end and a bottom end opposite each other, wherein the top end of the actuator is adapted to fit or engage with the aging cup, and wherein the bottom end of the actuator is adapted to fit or engage with the supporting base of the mixing cup.

10. The sludge and polymer conditioning system of claim 1, wherein the bottom end of the first reaction chamber includes a protruding portion that prevents movement of the mixing cup.

11. The sludge and polymer conditioning system of claim 1, wherein the top end of the first reaction chamber includes a protruding portion that prevents movement of the aging cup.

12. The sludge and polymer conditioning system of claim 1, wherein the first end of the spray nozzle includes an inlet adapted to receive the one or more mixed substances coming from the check valve.

13. A method for conditioning sludge with a polymer solution, comprising:
pumping a first substance into a mixing reactor via a progressive cavity pump, wherein the progressive cavity pump comprises a rotor and a stator, and the first substance is received through an inlet at a first end of the pump;
introducing at least a second substance into the mixing reactor via one or more inlets positioned perpendicularly to a hollow tube of the mixing reactor;
mixing the first and second substances using a drive shaft housed within the mixing reactor, wherein the drive shaft comprises a longitudinal body having a top end, a bottom end, and one or more impellers positioned between the top and bottom ends;
driving the mixing process by coupling an actuator to the top end of the drive shaft and coupling the bottom end of the drive shaft to the rotor of the progressive cavity pump;
directing the mixed substances from the mixing reactor into a first reaction chamber, wherein the first reaction chamber comprises a mixing cup at a bottom end and an aging cup at a top end;
further processing the mixed substances by passing them sequentially through the mixing cup and the aging cup within the first reaction chamber;
transferring the processed mixture from the first reaction chamber into a reducer connector, wherein the reducer connector comprises a hollow tube with a first end having a larger diameter than a second end;
controlling the flow of the processed mixture using a check valve positioned downstream of the reducer connector, wherein the check valve comprises a longitudinal body with an inlet at a bottom end and an outlet at a top end;
spraying the conditioned mixture through a spray nozzle having one or more orifices adapted to control the flow, direction, and spray pattern of the mixture;
applying the sprayed mixture within a second reaction chamber, wherein the second reaction chamber comprises a hollow cylindrical body with one or more sludge inlets and a sludge outlet at a top end;
discharging the conditioned sludge from the second reaction chamber via the sludge outlet, wherein the conditioned sludge exhibits a balanced and consistent polymer-to-sludge ratio.
